(19) United States
(12) Patent Application Publication
(10) Pub. No.: US 2011/0022540 A1
(43) Pub. Date: Jan. 27, 2011

(54) Location-Based Address Determination and Real Estate Valuation

(75) Inventors: Hadley Rupert Stern, West Newton, MA (US); John C. McDonough, Nahant, MA (US)

Correspondence Address: PROSKAUER ROSE LLP, ONE INTERNATIONAL PLACE, BOSTON, MA, 02110, US

(73) Assignee: FMR LLC, Boston, MA (US)

(21) Appl. No.: 12/508,514

(22) Filed: Jul. 23, 2009

(51) Int. Cl. G06Q 40/00; G06Q 50/00; G01S 1/00

(52) U.S. Cl. 705/36 R; 701/213

(57) ABSTRACT

Described are methods and apparatuses, including computer program products, for location-based address determination and real estate valuation. Current location information from a mobile device is received by a server computing device. The location information includes global positioning data associated with the mobile device and photographic data associated with one or more photos taken by the mobile device and associated with the location. A street address based on the location information is determined by the server computing device. The photographic data is processed in associated with the global positioning data, wherein the photographic data is used to determine the street address. Financial data associated with the street address is received.

### FIELD OF THE INVENTION

The subject matter of this application relates generally to methods and apparatuses, including computer program products, for location-based address determination and real estate valuation.

### BACKGROUND OF THE INVENTION

Mobile devices, such as cellular phones, personal digital assistant (PDA) devices, and smart phones, with global positioning system (GPS) features are becoming more commonplace. These devices can provide a determination, within some tolerance, of a user's location, frequently using a triangulation method for pinpointing the geographical coordinates of the device. Once determined, the location can be used to present the user with certain information (e.g., driving directions, local maps, people within the vicinity who also have a GPS device indicating their current location, and the like).

### SUMMARY

In one aspect, there is a computerized method for tracking activity patterns associated with mobile devices. Location information from a mobile device associated with a user is received by a server computing device. The location information is based on GPS information sent from the mobile device. The location information is tracked over a period of time. An occurrence of repeated activity is determined based on the tracking. One or more activity patterns are generated. The one or more activity patterns are associated with the mobile device. The one or more activity patterns are based on the occurrence of repeated activity.

In another aspect, there is a system for tracking activity patterns associated with mobile devices. The system includes a server computing device configured to receive location information from a mobile device associated with a user. The location information is based on GPS information sent from the mobile device. The location information is tracked over a period of time. An occurrence of repeated activity is determined based on the tracking. One or more activity patterns are generated. The one or more activity patterns are associated with the mobile device. The one or more activity patterns are based on the occurrence of repeated activity.

In another aspect, there is a system for tracking activity patterns associated with mobile devices. The system includes means for receiving location information from a mobile device associated with a user. The location information is based on GPS information sent from the mobile device. The system includes means for tracking the location information over a period of time. The system includes means for determining an occurrence of repeated activity based on the tracking. The system includes means for generating one or more activity patterns associated with the mobile device. The one or more activity patterns are based on the occurrence of repeated activity.

In another aspect, there is a computer program product for tracking activity patterns associated with mobile devices. The computer program product is tangibly embodied in a computer readable storage medium. The computer program product includes instructions operable to cause a data processing apparatus to receive location information from a mobile device associated with a user. The location information is based on GPS information sent from the mobile device. The location information is tracked over a period of time. An occurrence of repeated activity is determined based on the tracking. One or more activity patterns are generated. The one or more activity patterns are associated with the mobile device. The one or more activity patterns are based on the occurrence of repeated activity.

In some examples, any of the aspects can include one or more of the following features. The location information can include purchase history data, personal interests data, demographic data, social networking data, mobile device usage data, financial portfolio data, or any combination thereof. Tracking the location information can comprise storing the location information in a storage device upon receiving the information from the mobile device. The one or more activity patterns can include a travel route, a visited location, a purchase transaction, and a financial portfolio transaction. The generating can include retrieving personal information associated with the user, generating a characteristic of the one or more activity patterns based on the personal information, and associating the characteristic with the one or more activity patterns. The personal information can include purchase history data, personal interests data, demographic data, social networking data, mobile device usage data, financial portfolio data, or any combination thereof.

In other examples, the one or more activity patterns can be compared with a second activity pattern of a second user to determine a match between the one or more activity patterns and the second activity pattern. A message indicating the existence of a match between the one or more activity patterns of the user and an activity pattern of a second user can be sent.

In some examples, the message can include the location of the second user. The message can be sent to a mobile device application, a web site, an email account, an instant messaging service, or any combination thereof. The message can be generated based on receipt of a user query. The message can comprise a graphical representation of the locations of the users in comparison to each other.

In other examples, a safety index of the travel route can be determined based on crime data associated with locations in geographical proximity to the travel route. The crime data can include crime type, crime frequency, crime severity, crime density, or any combination thereof. The crime data can be based on law enforcement reports, news reports, user-submitted reports, or any combination thereof. The safety index of one or more locations in proximity to the travel route can be displayed. An alternate route having a higher safety index than the travel route can be provided to the user.

In some examples, a purchase history can be generated based on transactions performed by the user at the visited location. A message can be generated when the mobile device is in proximity to a location associated with a purchase transaction. The message can comprise rebate information, discount information, product information, spending information, or any combination thereof.

In other examples, an alert can be generated for one or more securities associated with a financial portfolio transaction. The alert can be sent to the user.

In some examples, one or more activity patterns can be associated with the time of day at which the location information was received. Location information can be automatically received at frequent intervals while the mobile device is active.

In another aspect, there is a computerized method for determining location-based real estate valuation. Current location information from a mobile device is received by a server computing device. The location information includes global positioning data associated with the mobile device and photographic data associated with one or more photos taken by the mobile device and associated with the location. A street address based on the location information is determined by the server computing device. The photographic data is processed in associated with the global positioning data, wherein the photographic data is used to determine the street address. Financial data associated with the street address is received.

In another aspect, there is a system for determining location-based real estate valuation. A server computing device is configured to receive current location information from a mobile device. The location information includes global positioning data associated with the mobile device and photographic data associated with one or more photos taken by the mobile device and associated with the location. A street address based on the location information is determined by the server computing device. The photographic data is processed in associated with the global positioning data, wherein the photographic data is used to determine the street address. Financial data associated with the street address is received.

In another aspect, there is a system for determining location-based real estate valuation. The system includes means for receiving current location information from a mobile device. The location information includes global positioning data associated with the mobile device and photographic data associated with one or more photos taken by the mobile device and associated with the location. The system includes means for determining a street address based on the location information. The photographic data is processed in associated with the global positioning data, wherein the photographic data is used to determine the street address. The system includes means for receiving financial data associated with the street address.

In another aspect, there is a computer program product, tangibly embodied in a computer readable storage medium, for determining location-based real estate valuation. The computer program product includes instructions operable to cause a data processing apparatus to receive current location information from a mobile device. The location information includes global positioning data associated with the mobile device and photographic data associated with one or more photos taken by the mobile device and associated with the location. A street address based on the location information is determined. The photographic data is processed in associated with the global positioning data, wherein the photographic data is used to determine the street address. Financial data associated with the street address is received.

In some examples, any of the aspects can include one or more of the following features. A real estate valuation can be generated based on the financial data. The real estate valuation can be compared with valuations of similar properties to generate a relative comparison value.

The financial data can include a sales price, an assessed tax amount, an appraisal value, an owner identification, or any combination thereof. Processing the photographic data can include determining a compass direction of the photographic data. Processing the photographic data can include identifying text contained within the photographic data. The real estate valuation can be transmitted to a remote device. A financial portfolio associated with an owner of the real estate can be retrieved.

Photographic data associated with one or more neighboring locations can be received when the current location is destroyed, wherein the photographic data is used to determine the street address of the destroyed location. Photographic data associated with one or more locations can be received, wherein the photographic data is used to generate a list of properties associated with the one or more locations. The list of properties can be filtered according to criteria identified by a user of the mobile device. The photographic data can be taken by a device that is separate from the mobile device. The photographic data can be transmitted to the mobile device via a communications link.

### DESCRIPTION OF FIGURES

FIG. 1 is a block diagram of an exemplary system for location-based information retrieval and aggregation for mobile devices.

FIG. 2 is a workflow diagram of an exemplary method for generating and tracking activity patterns for mobile devices.

FIG. 3 is a diagram of tracking location information over a period of time for generating and tracking activity patterns for mobile devices.

FIG. 4 is an example screenshot of a message sent by the server to the user's mobile device indicating the existence of a match between the activity patterns of a first user and other users.

FIG. 5 is an example screenshot of a message sent by the server to the user's mobile device indicating an activity pattern travel route of the user along with associated safety index values.

FIG. 6 is an example screenshot of a message sent by the server to the user's mobile device indicating a visited location activity pattern along with a purchase history and discount information.

FIG. 7 is an example screenshot of a message sent by the server to the user's mobile device indicating a financial portfolio transaction activity pattern along with an alert for a financial security (e.g., a stock holding) and financial portfolio information.

FIG. 8 is a flow diagram of an exemplary method for determining location-based real estate valuation using the system.

### DETAILED DESCRIPTION

In general overview, the techniques described below includes methods and apparatuses that are for location-based information retrieval and aggregation for mobile devices. The techniques are related to tracking the location information associated with the mobile device of a user and generating activity patterns based on the tracking, and location-based address determination and real estate valuation.

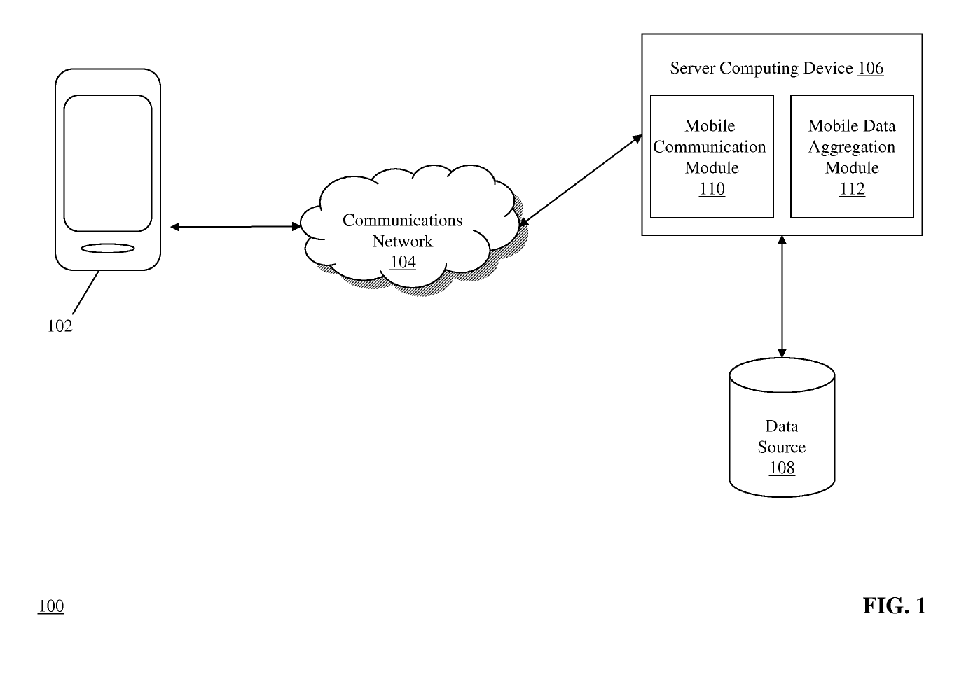

FIG. 1 is a block diagram of an exemplary system 100 for location-based information retrieval and aggregation for mobile devices. The system 100 includes a mobile computing device 102, a communications network 104, a server computing device 106, and a data source 108. The server 106 includes a mobile communication module 110 and a mobile data aggregation module 112. The server 106 and the data source 108 can reside at the same physical location or may be dispersed to different physical locations. The server 106 and the data source 108 can be located on the same physical device, or the data source 108 can be distributed on different physical devices. The server 106 and the data source 108 can communicate via a communications network, for example the communications network 104.

The mobile computing device 102 is the hardware that transmits location information to the server computing device 106, and receives messages and other information associated with the activity patterns. The location information can include several elements such as positioning coordinates, a date and/or timestamp, an identifier of the device providing the location information, and the like. Each transmission by the mobile device 102 can include a single location information entry, or a plurality of location information entries. The mobile device 102 can transmit the location information in real-time, or the mobile device 102 can store the location information locally, and then transmit the location information in a batch mode (e.g., once at the end of the day).

Example devices can include, but are not limited to a global positioning system (GPS) device, a smart phone, a portable video game system, an internet appliance, a personal computer, or the like. In some examples, the mobile device 102 can be installed in a vehicle. The mobile device 102 can be configured to include an embedded digital camera apparatus, and a storage module (e.g., Flash memory) to hold photographs, video or other information captured with the camera. The mobile device 102 includes network-interface components to enable the user to connect to a communications network 104, such as the Internet. The mobile device 102 also includes application software to enable the user to view messages and other information received from the server computing device 106. In some examples, the application software is browser software such as Microsoft Internet Explorer or Mozilla Firefox. In other examples, the application is an instant messaging application (e.g., AOL Instant Messenger), a short messaging service (SMS) application, or other social media application (e.g., Twitter). In other examples, the application can be a proprietary application written to implement any of the functionality described herein.

The server computing device 106 communicates with the mobile device 102 via a communications network, e.g., communications network 104. The server 106 includes a mobile communication module 110 and a mobile data aggregation module 112. The mobile communication module 110 provides a data interface between the mobile device 102 and the server 106. The mobile communication module 110 receives location information from the mobile device 102. The mobile data aggregation module 112 can track and categorize the received location information based on data elements associated with the location information such as location coordinates, an identifier (e.g., a MAC address) associated with the mobile device 102, a date, and/or a timestamp, in order to generate activity patterns associated with the mobile device 102. The mobile data aggregation module 112 can analyze one or more location information entries at a time to conduct the categorization. For example, if the a single location information entry includes positioning coordinates, a date and a timestamp, the mobile data aggregation module 112 can categorize the location information entry as a visited location. In another example, the mobile data aggregation module 112 can analyze several location information entries, each with a different location, from a single day. The mobile data aggregation module 112 can, for example, categorize the location information entries as a travel route. The mobile communication module 110 can transmit messages to the mobile device 102 based on one or more of the generated activity patterns.

The communications network 104 channels communications from the mobile device 102 to the server 106. The network 104 may be a local network, such as a LAN, or a wide area network, such as the Internet or the World Wide Web. The network 104 may utilize satellite communications technology. For example, the mobile device 102 may send and receive information via a communications link to a satellite, which in turn communicates with the server 106. The mobile device 102 and the server 106 can transmit data using a standard transmission protocol, such as XML, HTTP, HTTPS, SMS, or other similar data communication techniques.

The data source 108 holds tracking data associated with the mobile device 102. The tracking data can include location information and/or location information. The data source 108 can also hold data associated with the user, such as demographic data. Although one data source 108 is shown, there can be multiple data sources in the system 100. The data source can be a computing device hosting a database application. In other examples, the data source 108 can be a data feed received from various commercial and/or governmental entities which collect and make the requisite data available for retrieval by the server 106.

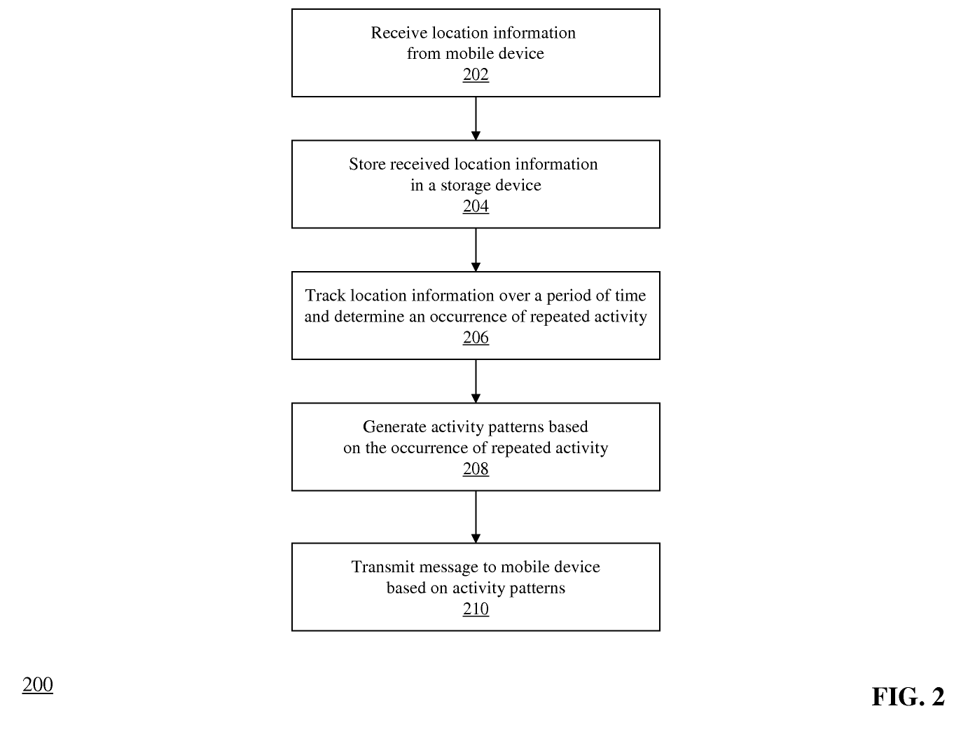

FIG. 2 is a flow diagram of an exemplary method for generating and tracking activity patterns for mobile devices. The mobile communication module 110 on the server 106 receives (202) location information from the mobile device 102 via the communications network 104. The server 106 stores (204) the location information in a storage device, e.g., data source 108. The mobile data aggregation module 112 on the server 106 tracks (206) the location information over a period of time and determines an occurrence of repeated activity based on the tracking. The mobile data aggregation module 112 generates (208) activity patterns based on the one or more categories of repeated activity. The mobile communication module 110 transmits (210) messages to the mobile device 102 based on the activity patterns.

The location information is associated with the mobile device 102. The location information can comprise geographical coordinates generated by GPS features of the mobile device 102. For example, the mobile device 102 can transmit the device's current location coordinates to the server 106.

The location information can be transmitted from the mobile device 102 to the mobile communication module 110 automatically. For example, when the mobile device 102 detects that its location has changed (i.e., the positioning coordinates have changed), the mobile device 102 can send location information to the mobile communication module 110 without requiring the user to input any information or otherwise interact with the mobile device. In some examples, the mobile device 102 can send location information to the mobile communication module 110 at regularly-timed intervals. For example, the mobile device 102 can be configured to send location information every five minutes. In other examples, the mobile device 102 can send location information based on an action by the user. For example, the user can make a phone call using the mobile device 102. When the user dials a phone number or presses a button to initiate the phone call, the mobile device 102 can send location information to the server 106.

In still other examples, the location information can be transmitted from the mobile device 102 to the mobile communication module 110 based on receipt of a request for location information from the mobile communication module 110. The request can be initiated by the mobile communication module 110 when the mobile data aggregation module 112 receives data from a data source, e.g., data source 108. For example, the mobile data aggregation module 112 can receive credit card transaction data from the data source 108 indicating that the user has just completed a purchase associated with the credit card. The mobile communication module 110 can then initiate a request for location information from the mobile device 102 to determine, for example, the location where the user made the purchase. The mobile device 102 can send the location information back to the mobile communication module 110 and the information can be stored for use by the mobile data aggregation module 112 in generating an activity pattern.

Once the location information is received by the mobile communication module 110, the server 106 can store the location information in a data source, e.g., data source 108. The server 106 can store data elements related to the location information, such as location coordinates, an identifier (e.g., a MAC address) associated with the mobile device 102, a date, and/or a timestamp. The server 106 can store a separate data entry each time location information is received. After the server 106 has stored a number of location information entries, the mobile data aggregation module 112 can track the mobile device 102 and generate an activity pattern by analyzing the location information. Analysis of the location information can occur, for example, by conducting comparisons, scans and other data evaluation techniques. The analysis can be implemented by utilizing proprietary database routines and instructions, or by leveraging common database commands to execute specific and unique sequences.

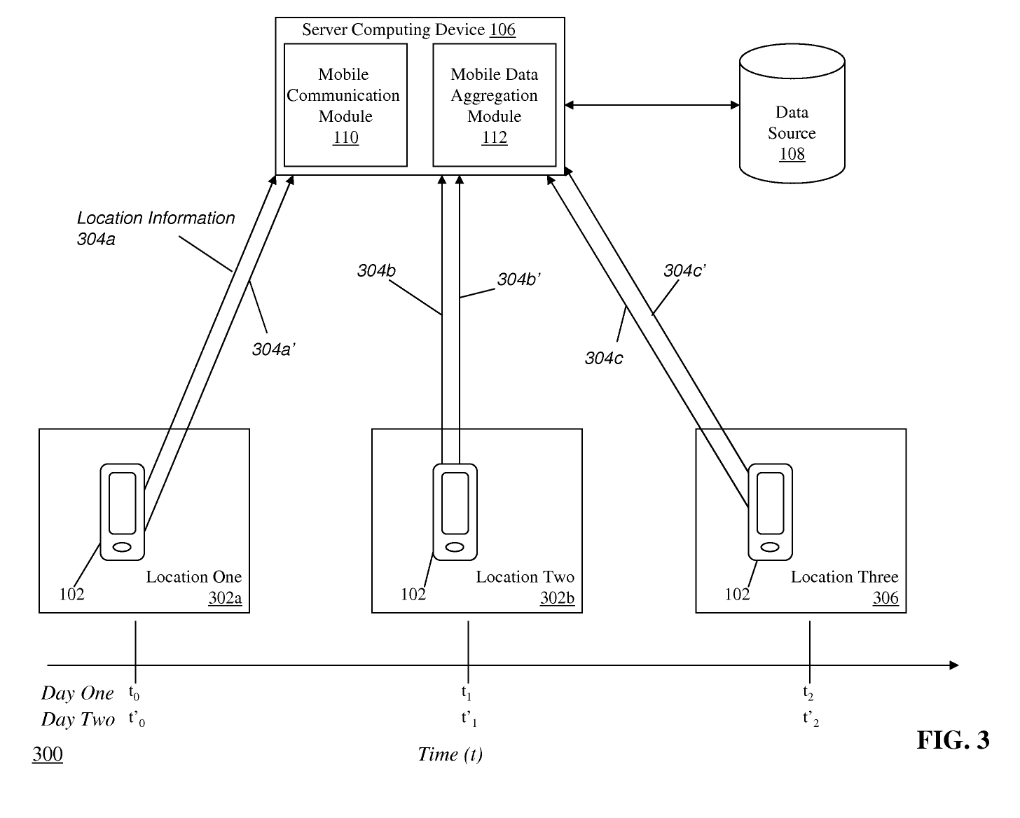

For example, the mobile data aggregation module 112 can determine that the mobile device 102 changed locations several times during a single time period (e.g., a day). FIG. 3 is a diagram of tracking location information over a period of time for generating and tracking activity patterns for mobile devices. On Day One at to, the mobile device 102 associated with a user is located at Location One 302a. The mobile device 102 sends location information 304a, which includes information associated with Location One 302a, to the server 106. The mobile communication module 110 stores the location information 304a in a data source 108. Later, at t₁, the mobile device 102 has moved to Location Two 302b. The mobile device 102 sends location information 304b associated with Location Two 302b to the server 106, and the mobile communication module 110 stores the information 304b. Finally, at t₂, the mobile device 102 has moved to Location Three 302c, and the mobile device 102 sends location information 304c associated with Location Three 302c, which is then stored by the mobile communication module 110. The next day, Day Two, at t′₀, the mobile device 102 is located at Location One 302a. The mobile device 102 sends location information 304a′ to the server 106. The mobile device 102 repeats the same sequence of locations (e.g., 302b and 302c), and at each location the mobile device 102 transmits location information (e.g., 304b′ and 304c′) to the server 106.

After the server 106 receives the location information entry 304c′ associated with Location Three 306 and Day Two, the mobile data aggregation module 112 can determine an occurrence of repeated activity (e.g., a travel route) based on all of the different location information entries 304a-c and 304a′-c′.

In some examples, the mobile data aggregation module 112 can analyze location information entries for a mobile device over a longer or shorter time period in order to determine an occurrence of repeated activity and generate an activity pattern. For example, the mobile data aggregation module 112 may determine an occurrence of repeated activity based on the location information entries compiled over a week. The mobile data aggregation module 112 may determine an occurrence of repeated activity based on a number of different time periods, e.g., hours, days, months, years, and the mobile data aggregation module 112 can generate activity patterns associated with any or all of the different time periods.

In some examples, the mobile data aggregation module 112 can generate an activity pattern based on two or more location information entries or groups of entries associated with a mobile device, e.g., mobile device 102, that share one or more common characteristics. The common characteristics can be based on the data elements of the individual location information entries, e.g., entries 304a-c and/or 304a′-c′. For example, if several different location information entries indicate that the user has visited a particular location at the same time every day (e.g., a coffee shop on Main Street at 7:45 am) for a month, the mobile data aggregation module 112 can utilize those common characteristics to determine that an activity pattern for the user includes the location data element and timestamp data element. The server 106 can store the activity pattern in a data storage device, e.g., data source 108.

The mobile data aggregation module 112 can incorporate the timestamp of the location information entries into determining an activity pattern. For example, the mobile data aggregation module 112 can determine that the mobile device 102 is associated with location information entries occurring each day that share a common location, and where the entries occur on or about the same time each day. The mobile data aggregation module 112 can use the timestamp in determining the activity pattern by, for example, more narrowly focusing the activity pattern to a specific time of day or by retrieving other information associated with the mobile device 102 or the user based on the time of day that other information was recorded.

The mobile data aggregation module 112 can also augment the activity patterns by retrieving additional information associated with the user from various data sources. The additional information can include purchase histories, personal interests or preferences, user demographics, social networking information, mobile device usage information, financial portfolio data, or other similar data associated with the user. Continuing with the example above, the mobile data aggregation module 112 can retrieve an activity pattern associated with the user—visiting a coffee shop on Main Street at 7:45 am—and apply additional information about the user to the activity pattern. For example, the mobile data aggregation module 112 can communicate with a data source (e.g., 108) that contains the user's bank account information and retrieve all debit card transactions conducted by the user at the Main Street coffee shop in the past month. The mobile data aggregation module 112 can extract the debit transactions that have a timestamp at or around 7:45 am, and the mobile data aggregation module 112 can associate those transactions with the activity pattern.

An example of a data source can be a user profile. In some examples, the user profile can include various types of information related to the user (e.g., demographics, finances, interests, etc.) and associated with a specific entity to which the user has a predefined relationship (e.g., Fidelity Investments, where the user has a mutual fund account). For example, the user profile could contain detailed information regarding the account. In other examples, the user profile can include information from third-party sources such as, for example, credit card companies, banks, social networking websites, email services, etc. The user profile can include information entered by the user and information retrieved from internal and/or external data sources. The user profile can be configurable by the user via a network application (e.g., a web page). The user could log in and update his user profile in order to tailor what kinds of data the mobile data aggregation module 112 can access. For example, the user could log in to his Fidelity account page and he could see that his Fidelity account is associated with two credit cards (e.g., one for his own use and one for his wife's use). The user could configure his user profile so that only information associated with the credit card for his own use appears when activity patterns are generated by the mobile data aggregation module 112.

The mobile data aggregation module 112 can categorize the activity pattern based on the type of activity. For example, referring to FIG. 3 if the location information entries indicate that the mobile device 102 has made multiple visits to a single location over a period of several days, the mobile data aggregation module 112 can analyze the location information entries by evaluating the positioning coordinates for each entry and determining that the coordinates are within close proximity to each other. Based on this analysis, the mobile data aggregation module 112 determines that the mobile device 102 has visited a particular location (e.g., Location One 302a) two or more times over a certain time period. The mobile data aggregation module 112 can then determine that a frequently visited location of the mobile device 102 is a visited location at Location One 302a, thus generating an activity pattern for that mobile device 102 associated with Location One 302a.

In another example, the mobile data aggregation module 112 can determine that the activity pattern is a purchase transaction. For example, if the location information entries indicate that the mobile device 102 has visited several different locations this week where each location is associated with a particular store franchise, the mobile data aggregation module 112 can analyze the location information entries and determine that the mobile device 102 has visited several different locations (e.g., Location One 302a, Location Two 302b, etc.) over a certain time period. The mobile data aggregation module 112 can augment the location information entries by determining that the visited locations share a common characteristic. For example, all of the locations contain a franchise location of a national coffee shop chain. The mobile data aggregation module 112 can further augment the location information entries by retrieving purchase transaction data associated with, for example, the user's bank account based on associating the date and time of the transactions with the entries. The mobile data aggregation module 112 can then determine that, for example, whenever the user visits a franchise of this particular coffee shop, he spends between $2.50 and $4.00 and purchases either (i) a medium coffee and a donut, or (ii) a medium latte and a bagel. The server 106 generates an activity pattern based on this activity.

In another example, the mobile data aggregation module 112 can determine that the activity pattern is a travel route. For example, if the location information entries indicate that the mobile device 102 has visited several different locations in the same sequence for the past three days, the mobile data aggregation module 112 can analyze the location information entries and determine that the mobile device 102 has visited a particular set of locations sharing similar positioning coordinates in the same sequence each day. Referring to FIG. 3, the mobile data aggregation module 112 can determine that the location information entries 304a-c for the mobile device 102 moved from Location One 302a to Location Two 302b to Location Three 302c consecutively over the course of a first day. The location information entries 304a′-c′ of that mobile device 102 for a second day—for example, immediately after the first day—can indicate that the mobile device 102 again moved from Location One 302a to Location Two 302b to Location Three 302c consecutively. The mobile data aggregation module 112 can analyze the location information entries for the first and second days 304a-c and 304a′-c′ to determine that the mobile device 102 has conducted the same travel route on each day. The mobile data aggregation module 112 can then determine that a repeated activity of the mobile device 102 is a travel route from Location One 302a to Location Two 302b to Location Three 302c, thus generating an activity pattern for that mobile device 102 associated with the travel route.

The mobile data aggregation module 112 can augment the location information entries for the travel route activity pattern by retrieving demographic data or personal preference data associated with the user of the mobile device. For example, the user may have provided personal preference data indicating jogging as a favorite activity. The mobile data aggregation module 112 can apply the jogging preference to the travel route and generate an activity pattern associated with jogging and the travel route.

Once an activity pattern has been generated, the mobile data aggregation module 112 can compare the activity pattern with an activity pattern of a second user to determine if the respective activity patterns match. The comparison can be based on characteristics associated with the activity pattern, such as the location information or timestamp information. The comparison can also include analysis of additional information associated with the user, such as demographic data or personal preference data. The respective activity patterns can be compared to determine a degree of similarity between the two activity patterns. In some examples, the comparison can be weighted to emphasize certain characteristics or data, thereby producing a different level of matching based on the weighting.

If the mobile data aggregation module 112 determines that a match exists between the respective activity patterns of the user and a second user, the server 106 can send a message to either or both users indicating the existence of a match. The message can also provide more detailed information associated with the activity patterns and the similarities between the patterns. In other examples, the user can submit a query to the server 106 requesting the location of other users nearby that share an activity pattern and/or other information with the user. For example, the user can submit the query by pressing a button or interacting in some other way with the mobile device 102.

Continuing with the above example, the mobile data aggregation module 112 can determine that a second user has indicated a personal preference for jogging as a favorite activity, and that the second user is associated with a travel route that is close to the user's travel route. The mobile data aggregation module 112 can determine that the respective activity patterns match based on the similar travel route and the shared favorite activity.

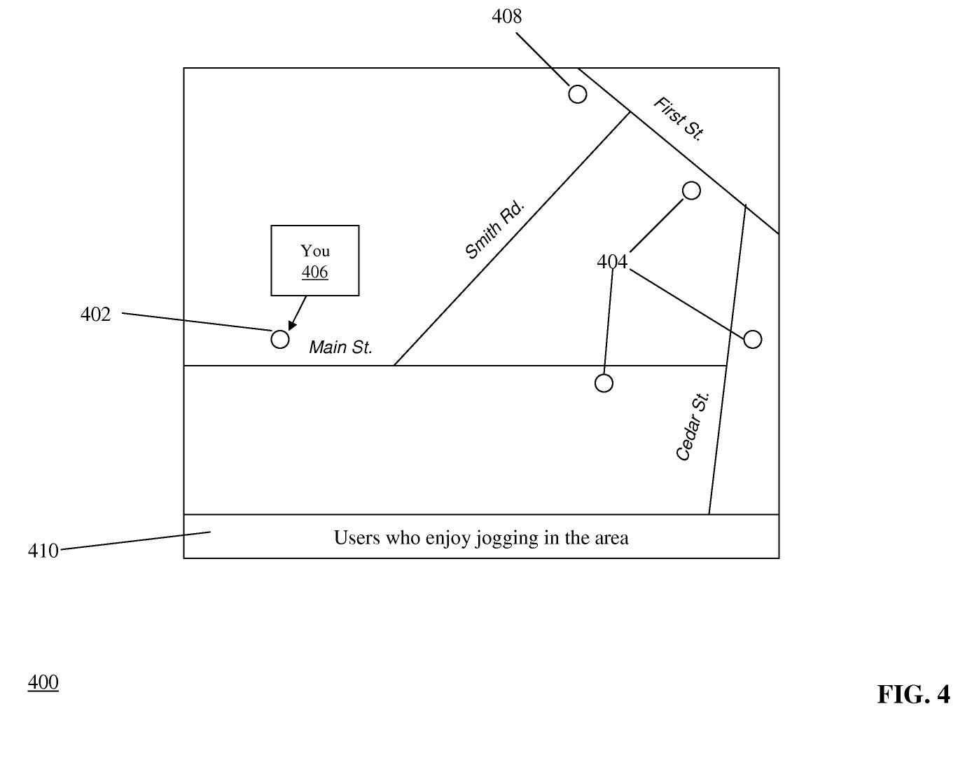

FIG. 4 is a example screenshot 400 of a message sent by the mobile communication module 110 to the user's mobile device 102 indicating the existence of a match between the activity patterns of a first user and other users. The message can include the location of the first user and any or all of the other users. For example, upon determining the existence of a match, the mobile communication module 110 can send a message as a graphical representation (e.g., a street map as seen in FIG. 4) of the first user's location 402 (identified as a clear dot). The first user's location 402 can include a text message 406 identifying the first user. The message can also include graphical representations of other users (e.g., shaded dots 404) in close proximity to the user 402, where the other users are associated with an activity pattern that matches the user's activity pattern. The message can also include a text message (not shown) identifying the respective other users. For example, the mobile data aggregation module 112 could determine that other users 404 also enjoy jogging and travel along similar daily routes, just like the user 402. The mobile communication module 110 can send a message for display on the first user's mobile device 102 containing the location of those other users 404, along with other information or characteristics about the users 404 that the first user 402 might have in common, such as a favorite hobby, etc. The message can also include a reference 410 to the shared activity pattern. As a result, the user 402 can quickly see other users 406 who have common activity patterns and are close to the user's 402 location.

The message can be sent to a plurality of different devices or accounts associated with the user. For example, the mobile communication module 110 can send the message to the user's mobile device 102. In other examples, the mobile communication module 110 can send the message to a web site, an email account, an instant messaging service, or other similar applications. The user can interact with any of these applications to receive the message from the mobile communication module 110.

In another example, the mobile data aggregation module 112 could determine that another user 408 (identified as a filled dot) is associated with the same activity pattern as the first user 402, but that user 408 is associated with characteristics that are in conflict with the first user 402. For example, the first user 402 may have indicated a favorite sports team, and the other user 408 indicated a favorite sports team that is the hated rival to the first user's 402 team. The mobile communication module 110 can also include the other user's location 408 in the same message, so that the first user 402 can know to avoid the other user 408.

In other examples, the mobile data aggregation module 112 need not determine the existence of a match between an activity pattern of a first user and a second user before the mobile communication module 110 sends a message to the mobile device 102 of the user. The mobile communication module 110 can send a message to the user's mobile device 102 based only on an activity pattern associated with the user, such as a visited location or purchase transaction.

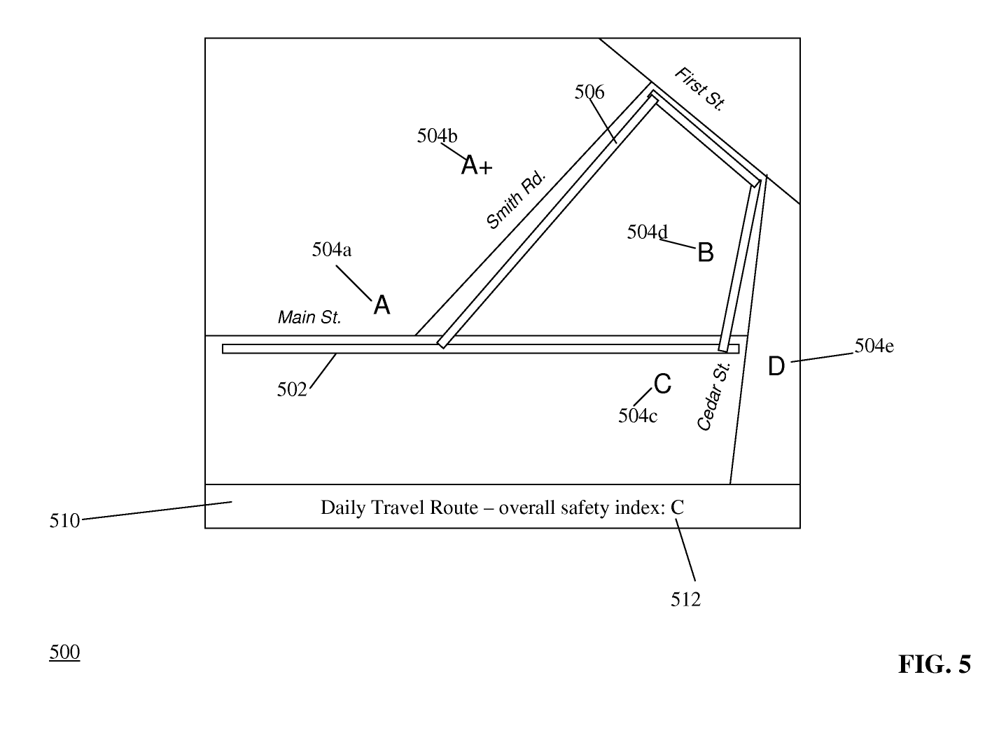

In some examples, where the mobile data aggregation module 112 has determined that the activity pattern is a travel route, the mobile data aggregation module 112 can determine a safety index based on crime data associated with locations in geographical proximity to the travel routes, and the mobile communication module 110 can send a message to the user's mobile device 102 displaying the travel route along with the safety index values. FIG. 5 is an example screenshot 500 of a message sent by the mobile communication module 110 to the user's mobile device 102 indicating an activity pattern travel route 502 of the user along with associated safety index values 504a-e. In determining the safety values 504a-e, the mobile data aggregation module 112 can retrieve a travel route activity pattern associated with the user. The mobile data aggregation module 112 can contact a data source 108 containing crime data related to locations in proximity to the user's travel route. The crime data can include crime type, crime frequency, crime severity, crime density, or any combination thereof. The crime data can be based on law enforcement reports, news reports, user-submitted reports, governmental reports, or other similar statistics or data. For example, the mobile data aggregation module 112 can retrieve the crime data from a database maintained by the FBI or the United States Justice Department.

Once the mobile data aggregation module 112 has retrieved the crime data, the mobile data aggregation module 112 can generate a safety index for each geographic location based on the crime data. The various data elements which comprise the crime data can be weighted by the mobile data aggregation module 112 based on a multitude of different proprietary and non-proprietary evaluation criteria. The safety index can be a number, a letter, or any other identifying character. The safety index can be associated with a single geographic location (e.g., a street or a neighborhood), or the safety index can be associated with a plurality of geographic locations (e.g., a travel route). The safety indexes can be generated using a relative scale, that is, different safety indexes associated with individual geographic locations in proximity to the user's overall travel route can be compared against each other to determine which safety index is the “best” (i.e., the safest) and that index is assigned the highest value. The remaining safety indexes associated with individual geographic locations are assigned lower values in comparison. Alternatively, the server 106 can generate the safety indexes associated with individual geographic locations independently of each other by basing the generation only on the crime data associated with those locations. The mobile data aggregation module 112 can also generate a safety index for the overall travel route by analyzing the individual safety indexes associated with geographical locations in proximity to the travel route.

After generating the safety index or indexes, the mobile communication module 110 can send a message to the user's mobile device 102, containing a graphical representation of the user's travel route activity pattern (represented as shaded path 502) and the safety indexes 504a-e of various locations in geographical proximity to the travel route 502. For example, the portion of the user's travel route 502 along Main Street to Smith Road can be represented with a safety index of A 504a (indicating a safe area) while the portion of the user's travel route from Smith Road to Cedar Street can be represented with a safety index of C 504c (indicating a moderately unsafe area). The mobile data aggregation module 112 can generate a safety index for the entirety of the user's travel route (e.g., ‘C’ safety index 512) and the mobile communication module 100 can send a text message 510, or mobile data aggregation module 112 can generate safety indexes 504a-e for various portions of the user's travel route 502. As a result, the user can quickly determine which areas are safer than other areas, and the safety of his overall travel route 502.

In some examples, the message can include an alternate travel route 506 (represented as solid gray path 506). The mobile data aggregation module 112 can determine that an alternate route in proximity to the activity pattern travel route 502 has a higher (i.e., safer) safety index than the user's current activity pattern. For example, the mobile data aggregation module 112 can generate a safety index of ‘A+’ 504b for an area between Main Street and First Street along Smith Road. The mobile data aggregation module 112 can determine that this alternate route 506 is safer than the user's current route, and the mobile communication module 110 can transmit the alternate route 506 to the user's mobile device 102 as part of the overall safety index message. In some examples, the user can request an alternate travel route from the server 106 by pressing a button on the mobile device 102 or entering an input using a generated user interface. In other examples, the device 102 can execute a customized application for display and manipulation of the travel route and location data. In still other examples, the mobile communication module 110 can automatically include the alternate travel route 506 in the message to the mobile device 102.

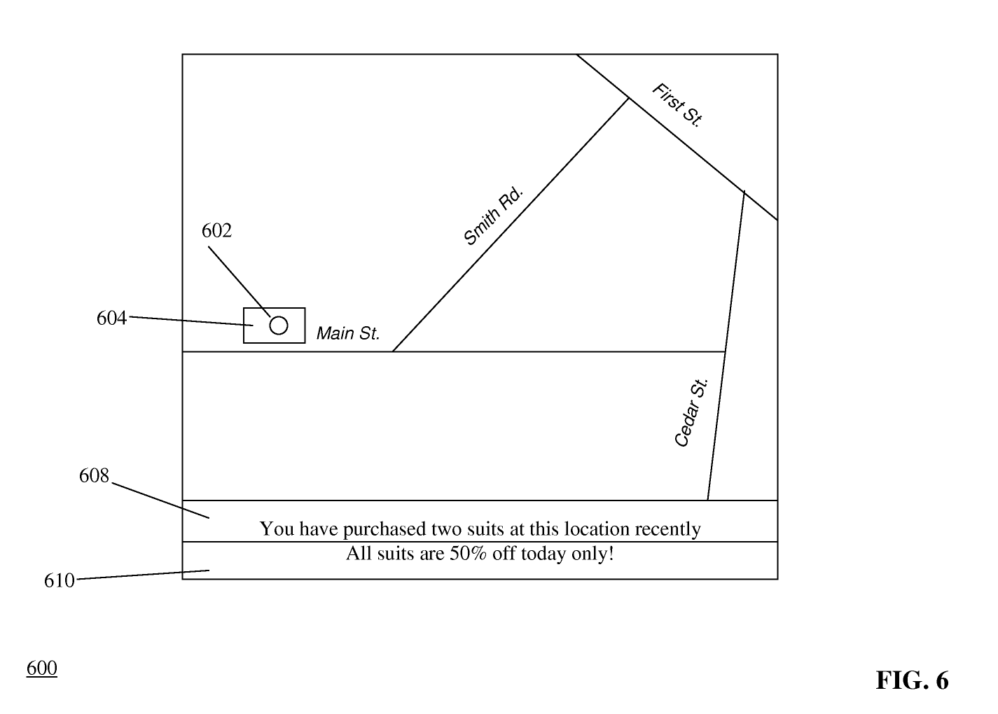

In another example, the mobile communication module 110 sends a message to the user's mobile device 102 based only on an activity pattern associated with the user, where the activity pattern is categorized as a visited location. FIG. 6 is an example screenshot 600 of a message sent by the mobile communication module 110 to the user's mobile device 102 indicating a visited location activity pattern along with a purchase history 608 and discount information 610. For example, the user 602 may be associated with an activity pattern indicating that she frequently visits a clothing store (represented by the shaded box 604) on Main Street. When the user 602 gets in close proximity to the store location 604, the mobile data aggregation module 112 detects the location of the user's mobile device 102 and determines that the user is associated with a visited location activity pattern for that store 604. The mobile data aggregation module 112 retrieves the user's purchase history associated with the store from a data source (e.g., 108), and the mobile data aggregation module 112 also retrieves current discount information associated with the store. The mobile communication module 110 sends a message to the user's mobile device 102 including a graphical representation of the user's location (e.g., a street map) along with text messages indicating the user's purchase history 608 and the current discount information 610 associated with the store 604. For example, the message can be sent via SMS, MMS, or Twitter (e.g., a ‘tweet’), with the device indicating the receipt of the message in a standard way, e.g., a vibration and/or audio signaling, timed such that the message is received when the user is in close proximity. In some examples, the indication can be a special indication different than the normal indication, such as a particular ring tone or prerecorded speech, so the user is less inclined to ignore the message timed for that particular location and moment.

In other examples, the user may be associated with a purchase transaction activity pattern related to the store 604. For example, the user 602 may have purchased several suits from different locations of the same clothing store chain over a certain time period. When the user 602 gets in close proximity to a particular store location 604 of that clothing store chain (regardless of whether the user has shopped at that individual location), the mobile communication module 110 can send a message (e.g., a text message or a tweet) to the user's mobile device 102 indicating the user's purchase history 608 and the discount information 610.

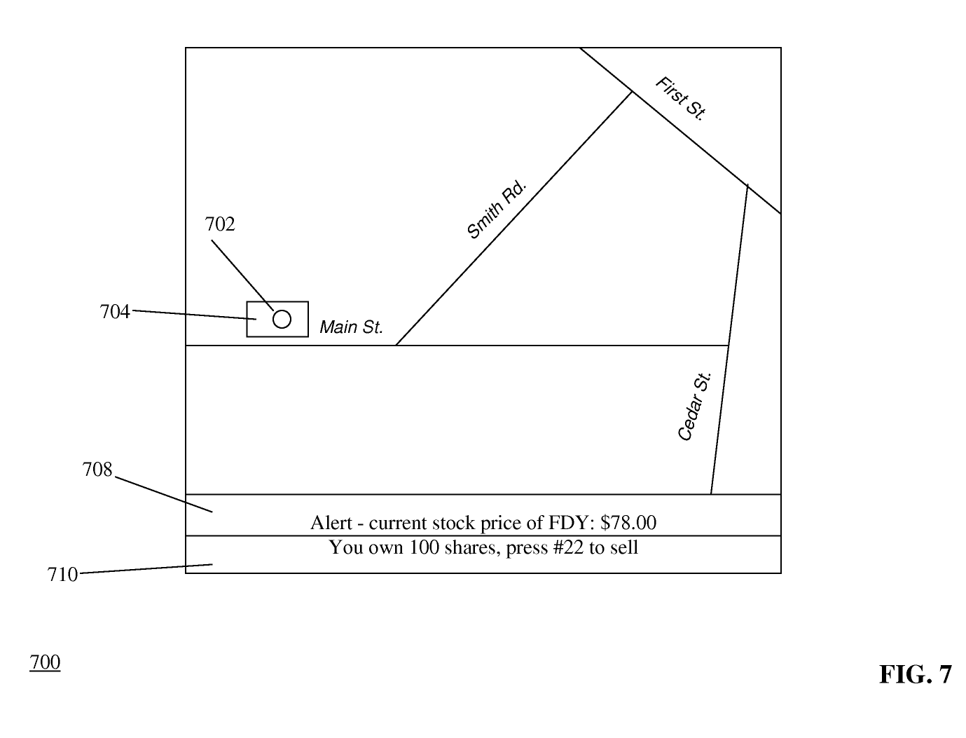

In other examples, the mobile communication module 110 sends a message to the user's mobile device 102 based on an activity pattern associated with the user, where the activity pattern is categorized as a financial portfolio transaction. FIG. 7 is an example screenshot 700 of a message sent by the mobile communication module 110 to the user's mobile device 102 indicating a financial portfolio transaction activity pattern along with an alert for a financial security 708 (e.g., a stock holding) and financial portfolio information 710. For example, the user 702 may frequently buy and sell certain securities associated with a corporation which are incorporated in her financial portfolio. When the user 702 gets in close proximity to a location (e.g., 704) associated with the corporation whose stock she holds or, alternatively, associated with the brokerage firm which manages her portfolio, the mobile data aggregation module 112 detects the location of the user's mobile device 102 and determines that the user is associated with a financial portfolio transaction activity pattern for that location 704. The mobile data aggregation module 112 may determine that only a subset of the securities owned by the user 702 are applicable to that location 704, or the mobile data aggregation module 112 may determine that all of the user's holdings are applicable to that location 704. In some examples, the mobile data aggregation module 112 retrieves the user's current holdings of a security (e.g., 100 shares of FDY stock) associated with that location 704 from a data source (e.g., 108), and the mobile data aggregation module 112 also retrieves current information associated with the security (e.g., a stock price of $78.00). The mobile communication module 110 sends a message to the user's mobile device 102 including a graphical representation of the user's location (e.g., a street map) along with text messages indicating the current stock price 708 and a total of shares owned by the user 710 which are associated with the location 704.

In some examples, the message may also include a prompt 712 which the user can follow to execute some action related to his or her financial portfolio. For example, the message may indicate that the user can sell 100 FDY shares by pressing the ‘#22’ sequence on the mobile device 102. In some examples, the user action can include pressing a button, speaking a word or phrase, or other similar user inputs for the mobile device 102. If the user presses the requisite sequence, the mobile device 102 sends an instruction to the server 106 to sell the stock. The server 106 transmits the request to a data source associated with the user's financial portfolio, which can then execute the desired transaction.

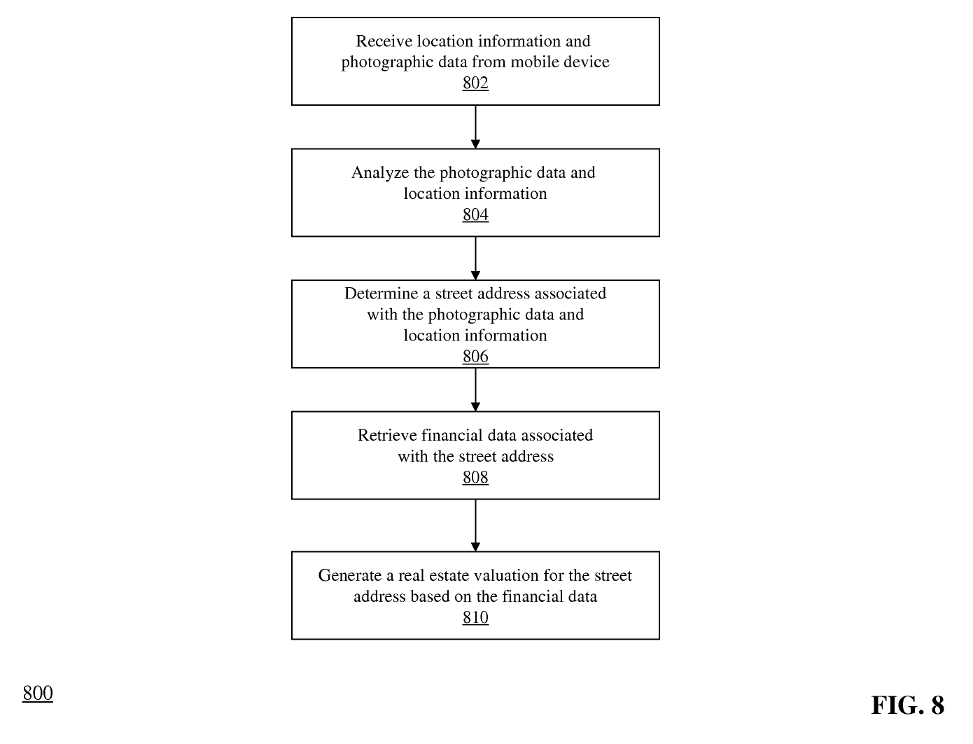

In other examples, the mobile data aggregation module 112 can collect and analyze location information from the mobile device 102 to determine real estate valuation associated with the mobile device's current location. FIG. 8 is a flow diagram of an exemplary method 800 for determining location-based real estate valuation using the system 100. The server 106 receives (802) location information and photographic data from the mobile device 102. The photographic data can be collected using a camera built in to the mobile device 102, or the photographic data can be collected using a camera that is separate from the mobile device 102 and then uploaded to the mobile device 102 via a communications link or cable. The mobile data aggregation module 112 analyzes (804) the photographic data in association with the location information. The mobile data aggregation module 112 determines (806) a street address associated with the photographic data and location information. The location information can include global positioning data generated by the mobile device 102 using techniques known in the art. The mobile data aggregation module 112 retrieves (808) financial data associated with the street address. The financial data can include a sales price, an assessed tax amount, an appraisal value, an owner identification, or any combination thereof. The mobile data aggregation module 112 generates (810) a real estate valuation based on the financial data associated with the street address and transmits the valuation and/or the financial data to the mobile device 102. The server 106 can store the valuation in a data source (e.g., 108) for future reference.

The mobile data aggregation module 112 determines the street address associated with the location and photographic data received from the mobile device 102 by comparing the data against one or more data sources containing identifying information. For example, the mobile communication module 110 receives a photograph of a building located at 12 Main Street from a user's mobile device 102, along with global positioning information related to the mobile device's current location. The mobile data aggregation module 112 processes the GPS data by accessing data sources which contain detailed information regarding the relationship between positioning coordinates and physical street addresses. Examples of such data sources include Google® Maps from Google, Inc., and MultiNet® from Tele Atlas. Once the mobile data aggregation module 112 has determined the location, the mobile data aggregation module 112 can process the photograph in a similar fashion, e.g., by comparing the photograph against data sources that contain an association between photographic information and street addresses and/or positioning data.

In some examples, the mobile data aggregation module 112 can utilize the compass direction of the photograph in order to determine the street address. For example, if the photograph was taken by the mobile device 102 facing the subject building from the west, the mobile data aggregation module 112 can match the western view of the building from a data source with the photograph and arrive at an identified street address.

In other examples, the mobile data aggregation module 112 can recognize text and numbers within the photograph in order to determine the street address. For example, if the number ‘229’ is affixed to the subject building and included within the photograph taken by the mobile device 102, the mobile data aggregation module 112 can utilize a text recognition module (not shown) to extract and parse the number from the photographic data. The mobile data aggregation module 112 can include the number in its identification of a street address.

In still other examples, when the location for which a real estate valuation is desired cannot be properly photographed (e.g., the location was destroyed by severe weather), the mobile communication module 110 can receive photographic data associated with locations in close proximity to the destroyed location and analyze the photographic data to determine a street address for the destroyed location. For example, an insurance claims adjuster is surveying the damage left behind by a tornado. The adjuster needs to determine the real estate value of a house that was destroyed by the storm in order to process an insurance claim. The adjuster notices that two houses adjacent to the destroyed house remain largely intact. The adjuster takes photographs of the two houses and the destroyed house with a mobile device 102, and transmits the photographs and other GPS data to the mobile communication module 110. The mobile data aggregation module 112 analyzes the photographs and GPS data according to the method above, and the mobile data aggregation module 112 determines that one photograph corresponds to a street address of 5 Main Street, another photograph (the destroyed house) cannot be identified, and the third photograph corresponds to a street address of 9 Main Street. The mobile data aggregation module 112 processes the compass direction and location information associated with the destroyed house photograph, and concludes that the street address is 7 Main Street. In some examples, the mobile data aggregation module 112 retrieves financial data associated with the respective street addresses and generates a real estate valuation for each property. In other examples, the mobile data aggregation module 112 retrieves financial data associated with only the destroyed street address and generates a real estate valuation for that property. The mobile communication module 110 then sends the valuation(s) to the adjuster's mobile device 102.

The mobile data aggregation module 112 can also compare the generated real estate valuation for the current location of the mobile device 102 with valuations of similar properties retrieved from a data source (e.g., 108) in order to generate a relative comparison value between the various properties. For example, as part of generating a real estate valuation for a requested street address, the mobile data aggregation module 112 can automatically compare the valuation of the requested street address with similar properties in the area (e.g., those with similar physical characteristics that recently sold) to determine an estimated appraisal or comparable valuation of the desired street address.

In other examples, the mobile communication module 110 can receive photographs of a plurality of buildings in an area and generate a list of for-sale or recently-sold properties that are located in those buildings. For example, the mobile communication module 110 receives photographs of several apartment buildings on Main Street which were taken by the mobile device 102, along with location information. In some examples, the mobile communication module 110 may also receive specific search criteria (e.g., only find two-bedroom apartments) from the mobile device 102. The mobile data aggregation module 112 analyzes the photographs and the location information to determine that the buildings are located at 24 Main Street and 26 Main Street. Instead of or in addition to providing real estate valuations for the buildings, the mobile data aggregation module 112 can generate a list of available or vacant apartments in the respective buildings that match the criteria received from the mobile device 102, and send the list back to the mobile device.

In other examples, the mobile data aggregation module 112 can retrieve financial information, such as a financial portfolio, associated with a recorded or identified owner of the street address. For example, as part of generating a real estate valuation for a requested street address, the mobile data aggregation module 112 can retrieve information about the owner of the property located at the street address, provided that information is available from a data source. The owner information can include name, home address, phone number, net worth, personal asset value, and financial portfolio information.

In other examples, the street address information can be used in combination with the safety index calculations described above. The mobile data aggregation module 112 can generate the safety index associated with a property or street address, and the mobile communication module 110 can send a message to the mobile device 102 containing the valuation information and the safety index. For example, if a user is interested in buying a particular house, in addition to financial information associated with that address, a safety rating would also be of importance to the user in determining whether to make the purchase.

The above-described systems and methods can be implemented in digital electronic circuitry, in computer hardware, firmware, and/or software. The implementation can be as a computer program product (i.e., a computer program tangibly embodied in a computer readable storage medium). The implementation can, for example, be in a machine-readable storage device and/or include a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array), an ASIC (application-specific integrated circuit), a DSP (digital signal processor), and/or any other discrete circuitry that is configured to implement the required functions. Modules, subroutines, and software agents can refer to portions of the computer program, the processor (included in a computing device, such as a server computing device), the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Computer readable mediums suitable for embodying computer program instructions and data include all forms of non-volatile memory, including by way of example semiconductor memory devices. The computer readable mediums can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device or a transmitting device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The client device and the computing device can include, for example, a computer, a computer with a browser device, a telephone, an IP phone, a mobile device (e.g., cellular phone, personal digital assistant (PDA) device, smart phone, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

The web servers can be, for example, a computer with a server module (e.g., Microsoft® Internet Information Services available from Microsoft Corporation, Apache Web Server available from Apache Software Foundation, Apache Tomcat Web Server available from Apache Software Foundation).

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network).

The system can include clients and servers. A client and a server are generally remote from each other and typically interact through a communication network. The relationship of client and server arises by virtue of computer programs running on the respective computers and having a client-server relationship to each other.

The above described communication networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A computerized method for determining location-based real estate valuation comprising:
receiving, by a server computing device, current location information from a mobile device, the location information including global positioning data associated with the mobile device and photographic data associated with one or more photos taken by the mobile device and associated with the location;
determining, by the server, a street address based on the location information by processing the photographic data in association with the global positioning data, wherein the photographic data is used to determine the street address;
retrieving financial data associated with the street address.

2. The method of claim 1, further comprising generating a real estate valuation based on the financial data.

3. The method of claim 2, further comprising comparing the real estate valuation with valuations of similar properties to generate a relative comparison value.

4. The method of claim 1, wherein the financial data includes a sales price, an assessed tax amount, an appraisal value, an owner identification, or any combination thereof.

5. The method of claim 1, wherein processing the photographic data further comprises determining the compass direction of the photographic data.

6. The method of claim 1, wherein processing the photographic data further comprises identifying text contained within the photographic data.

7. The method of claim 1, further comprising transmitting the real estate valuation to a remote device.

8. The method of claim 1, further comprising retrieving a financial portfolio associated with an owner of the real estate.

9. The method of claim 1, further comprising receiving photographic data associated with one or more neighboring locations when the current location is destroyed, the photographic data used to determine the street address of the destroyed location.

10. The method of claim 1, further comprising receiving photographic data associated with one or more locations, the photographic data used to generate a list of properties associated with the one or more locations.

11. The method of claim 10, wherein the list of properties is filtered according to criteria identified by a user of the mobile device.

12. The method of claim 1, wherein the photographic data is taken by a device that is separate from the mobile device; and wherein the photographic data is transmitted to the mobile device via a communications link.

13. A system for determining location-based real estate valuation comprising:
a server computing device configured to:
receive current location information from a mobile device, the location information including global positioning data associated with the mobile device and photographic data associated with one or more photos taken by the mobile device and associated with the location;
determine a street address based on the location information by processing the photographic data in association with the global positioning data, wherein the photographic data is used to determine the street address; and
retrieve financial data associated with the street address.

14. A system for determining location-based real estate valuation comprising:
means for receiving current location information from a mobile device, the location information including global positioning data associated with the mobile device and photographic data associated with one or more photos taken by the mobile device and associated with the location;
means for determining a street address based on the location information by processing the photographic data in association with the global positioning data, wherein the photographic data is used to determine the street address; and
means for retrieving financial data associated with the street address.

15. A computer program product, tangibly embodied in a computer readable storage medium, the computer program product including instructions operable to cause a data processing apparatus to:
receive current location information from a mobile device, the location information including global positioning data associated with the mobile device and photographic data associated with one or more photos taken by the mobile device and associated with the location;
determine a street address based on the location information by processing the photographic data in association with the global positioning data, wherein the photographic data is used to determine the street address; and
retrieve financial data associated with the street address.
